(19) United States
(12) Patent Application Publication
(10) Pub. No.: US 2003/0105743 A1
(43) Pub. Date: Jun. 5, 2003

(54) Use of database queries for manipulation of media content

(75) Inventor: Mark Ireton, Portland, OR (US)

Correspondence Address: Julie L. Reed, MARGER JOHNSON & McCOLLOM, P.C., 1030 S.W. Morrison Street, Portland, OR, 97205, US

(73) Assignee: SONICblue, Inc., Santa Clara, CA

(21) Appl. No.: 09/993,982

(22) Filed: Nov. 16, 2001

(51) Int. Cl. G06F 7/00

(52) U.S. Cl. 707/3

(57) ABSTRACT

A media system. The system includes a store of individual files of media content and a repository of meta-information that is related to the individual files of media content. The system also includes a query interface enabling creation of queries that are used on a database to identify files of media content that satisfy the query.

### BACKGROUND

1. Field

This disclosure relates to media playing systems, more particularly to media systems and methods to manage and manipulate media content on those systems.

2. Background

Media playing systems are those systems that allow users to play and experience different types of media content. These systems may include video players, music players, image viewers, etc. As more and more content is available in digital form, these systems are able to access more auxiliary information about the content, in addition to the content itself.

For example, music files may be available in several different digital forms. Tracks from a compact disc (CD) contain music in digital form, as do MP3 (Moving Picture Experts Group, Level 3) players and sources, among many other possible digital formats. Digital television broadcasts provide video signals in digital form, and Personal Video Recorders (PVR's) convert an incoming analog television signal to digital signals and store the content in digital form.

As these sources of digital content proliferate, users could become overwhelmed with the content and will require some means to access, organize and manage their content. Currently, each individual system may allow some rudimentary manipulation by the user to organize and manage the content. For example, music players allow users to create play lists, typically by adding one selected file at a time to a play list. Similarly, video recorders may allow users to recall certain files, or play recently recorded tracks.

However, these techniques and systems are inadequate to allow users to perform any management or manipulation of their content files. It would be useful if techniques were available to allow more robust management of the content.

### SUMMARY

One aspect of this disclosure is a media system. The system includes a store of individual files of media content, and a repository of meta-information. A query interface enables creation of queries and a database receives a query about the meta-information related to the individual files of media content and identifies content that satisfies the query.

### BRIEF DESCRIPTION OF THE DRAWINGS

The invention may be best understood by reading the disclosure with reference to the drawings, wherein:

FIG. 1 shows a media system, in accordance with the invention.

FIG. 2 shows an alternative embodiment of a media system, in accordance with the invention.

FIG. 3 shows a flowchart of one embodiment of a method to manipulate content files, in accordance with the invention.

FIG. 4 shows a graphical representation of a search to identify content, in accordance with the invention.

FIG. 5 shows a graphical representation of an alternative search to identify content, in accordance with the invention.

FIG. 6 shows a graphical representation of another alternative search to identify content, in accordance with the invention.

### DETAILED DESCRIPTION OF THE EMBODIMENTS

Media players take many different forms including digital music players, digital video players, digital video recorders with play back, digital cameras with displays, digital video cameras with displays, electronic book appliances, etc. The media is generally stored in some sort of digital format, such as MP3 files, MPEG-2,-4, or in the future MPEG-7, audio/visual files. In addition, many different sources for meta-information related to the content also exist.

In some instances, the meta-information related to the content may accompany the content. For example, in the digital music realm there are sources of meta-information about music files. Compact discs (CDs) may include Cdtext, which includes title information for tracks. Downloadable digital music files may also have accompanying meta-information. For example, the digital music format Bluematter plans to contain substantial meta-information about the content. Similarly, MPEG-4 has plans for packet headers that will include informational fields about the video data in the packet payload. The term meta-information as used here is the information about properties and attributes of the content.

As these services mature, the amount of meta-information available and the different types of content available will only increase. Users could become overwhelmed with the tasks of managing and manipulating the content to provide the desired experience. In addition to these services, the user may enter meta-information about a particular file as well. One embodiment of the invention provides a method for using this external information, whatever the source, about the content to access the content in useful and meaningful ways.

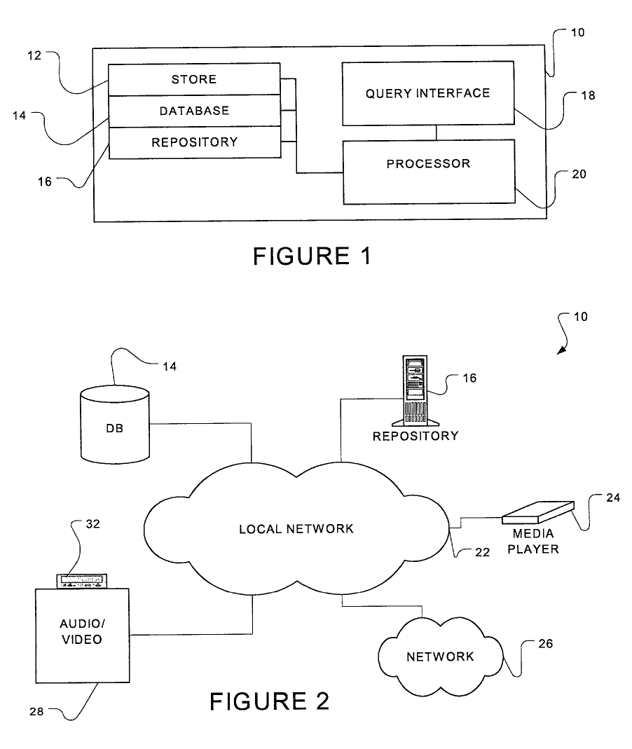

FIG. 1 shows an embodiment of a media system, in accordance with the invention. The media system in this example is self-contained, such as in a portable player. The system 10 includes a store of media content files 12, such as music files, video files or electronic books, as examples. A database 14 provides an index of the files and the meta-information, such as artist/author, title. This meta-information may be downloaded from a network, or accessed from a local repository 16, as shown in FIG. 1.

Typically, the repository will reside separate from the database and the store of content files, but the system may store a local copy or portion of the repository. For example, if a user has a portable player and wants to connect to a network or media server for only a limited time, the user may download a large amount of meta-information into the repository and the content files into the store and terminate the connection. The user may then direct the system to perform further processing on the system to update the database to reflect the new meta-information, and to synchronize the meta-information with the files currently on the player, off line from the connection.

In order to allow the user to utilize the meta-information in the database about the content files, the user may be presented with a query interface 18. The query interface is actually any interface that provides query capability, whether that is a user interface or an automated interface, such as one that automatically generates queries based upon some triggering event. The various configurations of user interfaces including touch screens, push buttons, sliders, voice interfaces, etc., are beyond the scope of the invention. If the query interface is a user interface, there is no limitation on the configuration. Generally, the queries will be generated by a query interface that relies upon a processor for converting the query into the appropriate format and accessing the database to sort and select content files that satisfy the query criteria.

While the system of FIG. 1 is shown as self-contained, many of the different components may reside separate from the others. As can be seen in FIG. 2, the system may be much broader in reach. In the example of FIG. 2, the repository of meta-information may reside on a media server separate from the database that links the meta-information to the various content files. The content files will more than likely reside on the media server/repository 16, but there is no requirement that they co-reside. Similarly, while the system shown in FIG. 2 indicates that the repository, the database and the various players reside on the same local network, the various members of the system could reside on other networks such as 26. The system may include several local or sub-networks in one far-flung network defined by the system.

Similarly, while the repository of content files 16 will more than likely act as the main source of content and meta-information, the other members of the network may include that meta-information as well. For example, if the media player 24 is a digital video player, that player 24 could access content and meta-information that resides on the audio/video system 28, including a set-top box 32. Additionally meta-information may be obtained from a remote source over the Internet, or other network, as part of a subscription, or other, service.

As discussed briefly above, the media system 10 has the capability of allowing manipulation of content on the system. The user can manipulate content and identify the desired content files by performing searches on the database. The system may desire to manipulate content as well, either to perform administrative tasks, such as automated updates, or ‘clean-up’ of old files, or may actually generate queries. For the purposes of this discussion, the term inquirer will include both users and the system. The database serves as an index of the available content and various attributes and properties of the content. The various attributes and properties come from the meta-information.

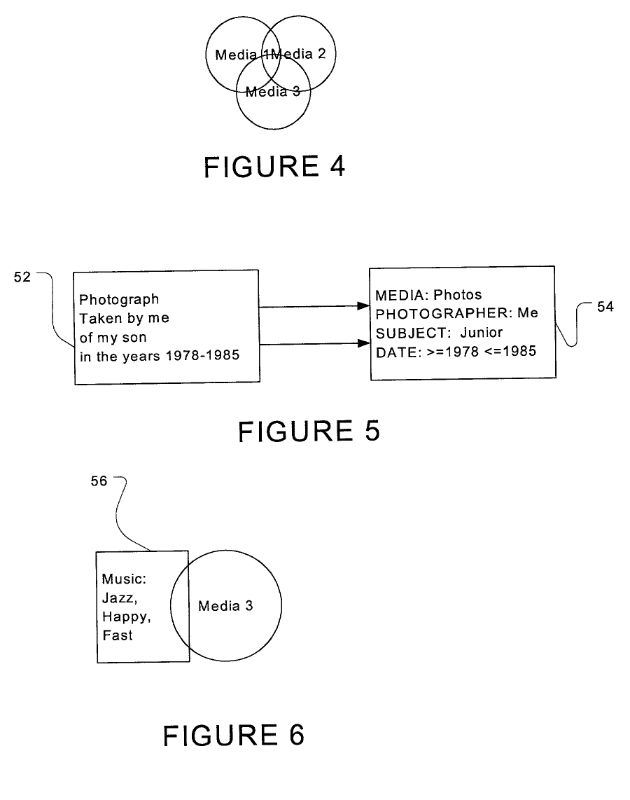

One manner in which the inquirer can manipulate the content is through search and sort queries performed on the meta-information that would result in the files being ordered in a certain way, or with certain files being identified. Examples of some possible types of queries are discussed with reference to FIGS. 4-6. These queries are just examples, and are not intended to limit the scope of the invention in any way. Similarly, the tasks of searching and sorting the media content files are merely examples of possible manipulation tasks that may be performed in application of the invention.

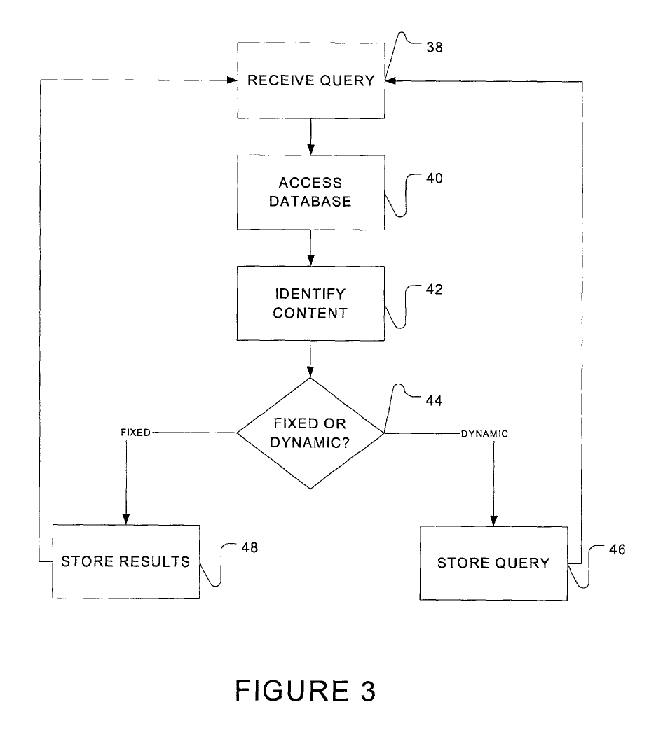

Generally, an embodiment of a method to manipulate content is shown in FIG. 3. Initially, reception of a new query will be discussed. The query is received by the media system at 38. The media system accesses the database at 40, using the parameters of the query in 38. For purposes of this discussion, the term parameter includes any definable attribute of a content file or the meta-information that may be used to sort or organize the information.

Once the database is accessed with the parameter or parameters of the query 40, the content satisfying the query is identified at 42. Identification of the content may include displaying a list, or file name, to the user, among other examples. There may be intervening processes used by the inquirer at this point, including naming the resulting identified content, alteration of the search/sort parameters, as will be discussed further, adding files to or deleting files from the identified content, as examples.

For new queries, once the query has been performed the inquirer will designate it as fixed or dynamic at 44. A fixed query results in storage of the results of the query at 48. For example, a user may want a ‘snapshot’ in time of a certain query. Storing the results has the affect of ‘freezing’ the results, in that no new files that may satisfy the query will be added to the result. For example, a user may perform a search for ‘all files for Louis Armstrong.’ The result is a list of all files for Louis Armstrong in the system at that point in time. The user may want to perform this type of query before adding new content, for example. The results may be stored in a file listed under the name of the play list, such as “Louis Armstrong files—as of Dec. 31, 2000.”

In contrast, a dynamic query stores the query parameter or parameters. This has the affect of producing new results every time the query is run. Files added or deleted between executions of the query will change the results. For dynamic queries, the system stores the query or some form of the parameters of the query at 46. Using the example above, the system may store the necessary parameters to re-execute the query “Louis Armstrong files.” When the user accesses what the user perceives as a play list, the user actually causes the system to re-execute the query.

The above discussion has dealt with newly generated queries. As can be seen in FIG. 3, once a query or results are stored, that same query may be used. At 38, the query received is a predefined query. At 40, the database is accessed. If the predefined query is a fixed query, accessing the database may only include accessing the file created of the results, or identifying the files location. This may be stored in the database as a field associated with the query that identifies the results file or its location in memory. As discussed above, if the query is a dynamic query, the system re-executes the query on the database, and the results are those files that satisfy the query at that point in time. For predefined queries, the inquirer may not have to specify whether the query is fixed or dynamic, unless the inquirer desires to change the status of the query.

Generally, embodiments of the invention may be implemented through software. An article of machine-readable media such as a computer diskette, a compact disc, or even a computer file may includes software code that is readable by a machine. When the software code is executed, the software causes the machine to perform the methods of the invention. A machine may be, but is not limited to, any of the components of the system shown in FIG. 2 as examples.

In FIG. 4, the query will be termed a ‘similar to’ query. The inquirer selects one or more pieces of content, such as Media 1, Media 2 and Media 3. The task is then to locate media files similar to these files. This may occur in several ways. One mechanism would be to find content similar to each of the supplied examples and then provide the combination of content as the result of the query. The actual mechanics of the ‘similar to’ query may be to access a predefined set of attributes for the example media and then finding all of those files with the same attributes. For example, Media 1 may have creation date of 1949. Media 2 may be a jazz recording. Media 3 may be a video of Louis Armstrong. The combined results would be all items created in 1949, all content about Louis Armstrong and all jazz recordings in the system.

A second embodiment of performing this type of query would be to combine the data from the examples and use the combined example to perform the search. The above example may turn into “all content about Louis Armstrong in 1949.” Many more advanced clustering mechanisms may be used to refine multiple examples into a smaller number of more generalized examples, which in turn are used to find content in the media system. Fuzzy matching techniques may also be used on subjective properties of the content. The 3 most important subjective properties, for instance, may be used as keys to find other similar content, i.e. content with a similar rating on the “important” subjective dimensions.

An alternative kind of query is a direct query. As shown in 52 of FIG. 5, the query is of ‘photographs taken by me between 1978 and 1985 of my son.” The conversion to search terms may be that shown in 54. This example assumes that all of the required characteristics or attributes of the desired files are ANDed together. Any logical operator could be used. This is only intended as an example.

FIG. 6 shows an alternative embodiment of a query and that query in a combination query. The window 56 shows what will be referred to here as a mood-based query. This is similar to a direct query, but the specifications are not as definite, these are referred to as ‘fuzzy’ queries. “Fast” may indicate a range of speeds with no clear boundaries, as does “Happy.” Queries such as this can be adjusted by the results they return and user feedback. When the query returns a group of songs within a certain range of beats per minute, for example, the user may unselect several of the songs that are at the slower end of the range. The system may automatically update the term ‘Fast’ to be songs with a beats per minute rating higher than those songs deleted. Similarly, the inquirer can specify more or fewer files returned as a result of the query adjusting ranges on the queries.

As mentioned above, these queries may be included as part of the software code that is readable by a machine. When the machine reads the code the code causes the machine to perform the methods of the queries.

Thus, although there has been described to this point a particular embodiment for a method and apparatus for manipulation of content on media systems, it is not intended that such specific references be considered as limitations upon the scope of this invention except in-so-far as set forth in the following claims.

What is claimed is:

1. A media system, comprising:
a store of individual files of media content;
a repository of meta-information, wherein the meta-information relates to the individual files of media content;
a query interface to enable creation of queries; and
a database operable to receive a query about the meta-information related to
the individual files of media content and identify files of media content that satisfy the query.

2. The system of claim 1, wherein the store, repository, query interface and database reside on one device.

3. The system of claim 1, wherein the store, query interface and database reside on one device and the repository resides separate from the device.

4. The system of claim 1, wherein the store and query interface reside on one device and the repository and database reside separate from the device.

5. The system of claim 1, wherein the query interface resides on one device and the store, database and repository reside separate from the device.

6. The system of claim 1, wherein the individual files of media content further comprises files of at least one of the group comprised of: video, audio, photographs and text.

7. The system of claim 1, wherein the query interface further comprises a user interface.

8. The system of claim 1, wherein the query interface further comprises an automated interface.

9. A method of manipulating content in a media system, the method comprising:
receiving a query;
accessing a database of meta-information relating to content files, using the query;
identifying content from the database of meta-information; and
storing a form of the query.

10. The method of claim 9, wherein receiving a query further comprises receiving a query through a user interface.

11. The method of claim 9, wherein receiving a query further comprises receiving a query from an automated interface.

12. The method of claim 9, wherein the query is fixed.

13. The method of claim 12, wherein the form of the query further comprises fixed results of the query.

14. The method of claim 9, wherein the query is dynamic.

15. The method of claim 14, wherein the form of the query further comprises the query.

16. A method of manipulating content in a media system, the method comprising:
receiving a predefined query;
accessing a database including meta-information about queries; and
identifying content that satisfies the query.

17. The method of claim 16, wherein the predefined query is a fixed query.

18. The method of claim 17, wherein accessing the database further comprises locating previously stored results for that query.

19. The method of claim 18, wherein identifying content further comprises providing the previously stored results.

20. The method of claim 16, wherein the predefined query is a dynamic query.

21. The method of claim 20, wherein accessing the database further comprises initiating a new query using the predefined query.

22. The method of claim 21, wherein identifying content that satisfies the query further comprises identifying those content files for which the meta-information in the database satisfies the new query.

23. An article of machine-readable media including code that, when executed, causes the machine to:
receive a query;
access a database of meta-information relating to content files, using the query;
identify content from the database of meta-information; and
store a form of the query.

24. The method of claim 23, wherein the code causing the machine to receive a query further comprises code that causes the machine to receive a query through a user interface.

25. The method of claim 23, wherein the code causing the machine to receive a query further comprises code that causes the machine to receive a query through an automated interface.

26. An article of machine-readable media including code that, when executed, causes the machine to:
receive a predefined query;
access a database including meta-information about queries; and
identify content that satisfies the query.

27. The method of claim 26, wherein the code that causes the machine to access the database further comprises causing the machine to locate previously stored results for that query.

28. The method of claim 26, the code that causes the machine to access the database farther comprises causing the machine to provide the previously stored results.
